(19) United States
(12) Patent Application Publication
(10) Pub. No.: US 2026/0128545 A1
(43) Pub. Date: May 7, 2026

(54) ASSEMBLY OF PLUG-IN CONNECTOR COMPONENT, AND PLUG-IN CONNECTOR COMPONENT AND SYSTEM

(71) Applicant: HARTING ELECTRIC STIFTUNG & CO. KG, Espelkamp (DE)

(72) Inventors: Hongwei YU, Zhuhai (CN); Yingtao WANG, Zhuhai (CN)

(21) Appl. No.: 19/118,171

(22) PCT Filed: Sep. 14, 2023
(86) PCT No.: PCT/IB2023/059113

§ 371 Date: Apr. 3, 2025

(30) Foreign Application Priority Data
Oct. 8, 2022 (CN) 202211222429.6

(51) Int. Cl. H01R 13/428; H01R 13/436; H01R 13/506; H01R 13/64; H01R 13/652

(52) U.S. Cl. CPC H01R 13/428; H01R 13/436; H01R 13/506; H01R 13/652; H01R 13/64

(57) ABSTRACT

An assembly of a plug-in connector component, and a plug-in connector component and system are disclosed. The assembly of a plug-in connector component includes: an insulator, the insulator including: a plug-in section, which can be plug-connected in a plug-in direction with a mating plug-in section of an insulator of an assembly of a mating plug-in connector component; and a grounding element mounting section, the grounding element mounting section extending from the plug-in section in a direction opposite to the plug-in direction; a grounding element, mounted in the grounding element mounting section and including grounding element body and a housing contact portion provided at an end of the grounding element body; and a contact piece, including contact piece mounting portion and a contact extending from the contact piece mounting portion in the plug-in direction, the contact piece mounting portion mounting the contact piece to the insulator.

### BACKGROUND

### Technical Field

The present application relates to the field of plug-in connectors. In particular, the present application relates to an assembly of a plug-in connector component, and a plug-in connector component and system.

### Description of the Related Art

A plug-in connector is used to provide connection between cables, and is used to transmit electric power and/or signals.

The plug-in connector has a terminal provided within a housing and a retainer for the terminal, the terminal being fixed in the retainer. The plug-in connector is plug-connected to a mating plug-in connector, to form an electrical connection between terminals. The retainer is made of an insulator, to prevent a current from being conducted from the terminal to the outside of the housing of the plug-in connector, thereby causing damage to personnel and devices.

The plug-in connector may be provided with a grounding element; the grounding element is used for grounding the plug-in connector.

The plug-in connector has a plurality of components, and assembling of various components makes it difficult to assemble the whole plug-in connector.

### BRIEF SUMMARY

Embodiments of the present application provide an assembly of a plug-in connector component, and a plug-in connector component and system, so as to at least solve the problem that it is difficult to mount a plug-in connector in the prior art.

According to one aspect of embodiments of the present application, provided is an assembly of a plug-in connector component, comprising: an insulator, the insulator being made of an electrically insulating material, the insulator comprising: a plug-in section, which can be plug-connected in a plug-in direction with a mating plug-in section of an insulator of an assembly of a mating plug-in connector component, the plug-in section being provided with a through hole for accommodating a contact; and a grounding element mounting section, the grounding element mounting section extending from the plug-in section in a direction opposite to the plug-in direction, the grounding element mounting section including a side wall and at least one opening provided on the side wall, the opening communicating the inner side and the outer side of the side wall; a grounding element, mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening; and a contact piece, comprising a contact piece mounting portion and a contact extending from the contact piece mounting portion in the plug-in direction, the contact piece mounting portion mounting the contact piece to the insulator, and the contact extending into the through hole.

In this way, a grounding element is provided in the assembly of the plug-in connector component, so as to provide grounding for the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, the insulator further includes a ground wire fixing portion, the ground wire fixing portion is provided in the center of the space surrounded by the side wall of the grounding element mounting section, and is used for fixing a ground wire; and the grounding element body includes a protective ground contact, the protective ground contact being in contact with the ground wire.

In this manner, a ground wire fixing manner is provided in the assembly of a connector component, such that the ground wire is provided in the center of the assembly of a connector component so as not to be exposed to the outside, the fixing of the ground wire is stable and safe, and the ground wire can be easily connected to the grounding element body at the same time.

According to exemplary embodiments of the present application, the insulator further includes a contact piece mounting section extending from the grounding element mounting section in the direction opposite to the plug-in direction, and the contact piece mounting portion of the contact piece includes a contact fixing portion and a mounting plate arranged on the periphery of the contact fixing portion, wherein the contact fixing portion fixes the contact on the inner side of the mounting plate, and the mounting plate mounts the contact piece mounting portion on the contact piece mounting section.

In this manner, the contact piece is easily mounted in the assembly of the plug-in connector component, and at the same time, the grounding element is facilitated to be fixed in the assembly of the plug-in connector component, thereby realizing a simple mounting manner of the assembly of the plug-in connector component.

According to exemplary embodiments of the present application, a first fixing structure is arranged on the outer side of the contact piece mounting section, a second fixing structure engaging with the first fixing structure is arranged on the mounting plate, and the contact piece mounting portion is mounted on the contact piece mounting section by the engagement of the first fixing structure with the second fixing structure.

In this way, the contact piece can be quickly mounted to the contact piece mounting section of the insulator without using tools such as screws for connection.

According to exemplary embodiments of the present application, the assembly of a plug-in connector component further comprises: a coding element arranged on one side of the plug-in section of the insulator and extending along the plug-in direction; and the assembly of the plug-in connector component can be plug-connected with the assembly of the mating plug-in connector component if the coding element is matched with a mating coding element of the assembly of the mating plug-in connector component.

In this way, multiple coding forms are provided for the assembly of the plug-in connector component, thereby facilitating connection of the assembly of the plug-in connector component to an assembly of a correct mating plug-in connector component, and avoiding connection to wrong devices.

According to exemplary embodiments of the present application, in the case of the assembly of the plug-in connector component being plug-connected with the assembly of the mating plug-in connector component, the contact of the contact piece of the assembly of the plug-in connector component is electrically connected to a mating contact of a contact piece of the assembly of the mating plug-in connector component.

In this manner, when the assembly of the plug-in connector component is plug-connected with the assembly of the mating plug-in connector component, a safe and stable electrical connection between devices is provided.

According to another aspect of the embodiments of the present application, further provided is a plug-in connector component, comprising: an assembly of the plug-in connector component, comprising: an insulator, the insulator being made of an electrically insulating material, the insulator comprising: a plug-in section, which can be plug-connected in a plug-in direction with a mating plug-in section of an insulator of an assembly of a mating plug-in connector component, the plug-in section being provided with a through hole for accommodating a contact; and a grounding element mounting section, the grounding element mounting section extending from the plug-in section in a direction opposite to the plug-in direction, the grounding element mounting section including a side wall and at least one opening provided on the side wall, the opening communicating the inner side and the outer side of the side wall; a grounding element, mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening; and a contact piece, comprising a contact piece mounting portion and a contact extending from the contact piece mounting portion in the plug-in direction, the contact piece mounting portion mounting the contact piece to the insulator, and the contact extending into the through hole; and the plug-in connector component further comprises: a housing, including an inner space for mounting the insulator, and the housing contact portion of the grounding element being in ground contact with the housing.

In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, the insulator includes a housing mounting section between the plug-in section and the grounding element mounting section and protruding circumferentially, the housing mounting section mounting the insulator to the housing.

In this way, a stable connection manner between the housing and the insulator is achieved.

According to another aspect of the embodiments of the present application, further provided is a plug-in connector system, comprising: a first plug-in connector component and a mating second plug-in connector component in plug-in connection, wherein the first plug-in connector component and the mating second plug-in connector component respectively include: an assembly of the plug-in connector component, comprising: an insulator, the insulator being made of an electrically insulating material, the insulator comprising: a plug-in section, which can be plug-connected in a plug-in direction with a mating plug-in section of an insulator of an assembly of another mating plug-in connector component, the plug-in section being provided with a through hole for accommodating a contact; and a grounding element mounting section, the grounding element mounting section extending from the plug-in section in a direction opposite to the plug-in direction, the grounding element mounting section including a side wall and at least one opening provided on the side wall, the opening communicating the inner side and the outer side of the side wall; a grounding element, mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening; a contact piece, comprising a contact piece mounting portion and a contact extending from the contact piece mounting portion in the plug-in direction, the contact piece mounting portion mounting the contact piece to the insulator, and the contact extending into the through hole; and a housing, including an inner space for mounting the insulator, and the housing contact portion of the grounding element being in ground contact with the housing.

In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, in the case of the first plug-in connector component being plug-connected with the mating second plug-in connector component, the contact of the first plug-in connector component is electrically connected to a contact of the mating second plug-in connector component.

In this manner, when the assembly of the plug-in connector component is plug-connected with the assembly of the mating plug-in connector component, a safe and stable electrical connection between devices is provided.

According to another aspect of the embodiments of the present application, further provided is a method for mounting an assembly of a plug-in connector component, said method comprising: mounting a grounding element in a grounding element mounting section of an insulator of the assembly, wherein a grounding element body of the grounding element is provided at the inner side of a side wall of the grounding element mounting section, and a housing contact portion of the grounding element is provided on the outer side of the side wall through an opening provided on the side wall; fixing a contact on the inner side of a mounting plate through a contact fixing portion; and mounting a contact piece mounting portion on a contact piece mounting section through the mounting plate, so that the contact extends into a through hole of a plug-in section of the insulator.

In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, the insulator is mounted to a housing by a housing mounting section of the insulator, and the housing contact portion of the grounding element is in ground contact with the housing.

Embodiments of the present application provide a technical solution of an assembly of a plug-in connector component, and a plug-in connector component and system, so as to at least solve the technical problem of inconvenience in an assembling manner of multiple components of a plug-in connector, and achieve the technical effects of easily and safely grounding the plug-in connector and easily assembling the plug-in connector.

### BRIEF DESCRIPTION OF THE SEVERAL VIEWS OF THE DRAWINGS

Drawings described herein are used to provide further understanding of the present application and constitute a part of the present application. The exemplary embodiments of the present application and the description thereof are used to explain the present application, but do not constitute improper limitations to the present application. In the drawings:

FIG. 1 is a schematic diagram of an assembly of a plug-in connector component according to embodiments of the present application;

FIG. 2 is a schematic diagram of a grounding element according to embodiments of the present application;

FIG. 3 is a cross-sectional view of an assembly of a plug-in connector component showing a grounding element according to embodiments of the present application;

FIG. 4 is a schematic diagram of an assembly of a plug-in connector component according to another embodiment of the present application;

FIG. 5 is a schematic diagram of an assembly of a mating plug-in connector component according to embodiments of the present application;

FIG. 6 is a schematic diagram of a plug-in connector component according to embodiments of the present application;

FIG. 7 is a schematic diagram of a plug-in connector system according to embodiments of the present application; and

FIG. 8 is a flowchart of a method for mounting an assembly of a plug-in connector component according to embodiments of the present application.

### DETAILED DESCRIPTION

In order to make a person skilled in the art better understand solutions of the present application, the technical solutions in the embodiments of the present application will be clearly and completely described below in combination with the drawings in the embodiments of the present application. It is apparent that the described embodiments are not all embodiments but part of embodiments of the present application. All other embodiments obtained by a person of ordinary skill in the art on the basis of the embodiments in the present application without involving any inventive effort shall fall within the scope of protection of the present application.

It should be noted that the terms “first,” “second,” etc., in the description, claims, and accompanying drawings of the present application are used to distinguish similar objects, and are not necessarily used to describe a specific sequence or order. It should be understood that the data so used may be interchanged where appropriate, so that the embodiments of the present application described herein can be implemented in sequences other than those illustrated or described herein. In addition, the terms “comprise” and “have,” and any variations thereof are intended to cover a non-exclusive inclusion, for example, a process, method, system, product, or device that comprises a series of steps or modules or units is not necessarily limited to those steps or modules or units that are clearly listed, but may comprise other steps or modules or units that are not clearly listed or inherent to such process, method, product, or device.

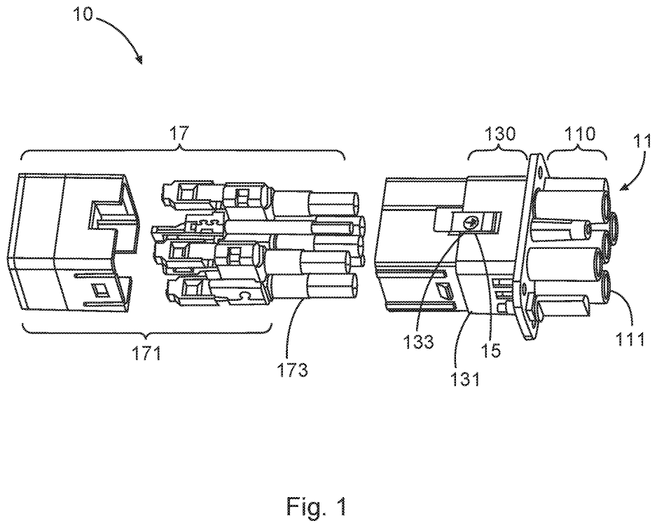

According to embodiments of the present application, an assembly of a plug-in connector component is provided. FIG. 1 is a schematic diagram of an assembly of a plug-in connector component according to embodiments of the present application. As shown in FIG. 1, the assembly 10 of the plug-in connector component comprises an insulator 11, a grounding element 15 and a contact piece 17.

The insulator 11 is made of an electrically insulating material, and is used to avoid a short circuit and power leakage between internal and external electronic elements. The electrically insulating material is not limited to plastic. The insulator 11 and a mating insulator can be plug-connected to each other along a longitudinal direction. Along the longitudinal direction (plug-in direction), the insulator 11 can be considered to comprise multiple sections. For example, the insulator 11 includes a plug-in section 110 and a grounding element mounting section 130.

As shown in FIG. 1, the plug-in section 110 is a section for accommodating a contact, can be plug-connected in a plug-in direction with a mating plug-in section of an insulator of an assembly of a mating plug-in connector component, and the plug-in section 110 is provided with a through hole 111 for accommodating the contact. The number of the through holes may be one or more, and the specific number is determined according to the number of contacts actually accommodated. For example, five through holes 111 are shown in FIG. 1, for accommodating five contacts. It should be understood that the number of the through holes 111 is not limited to five, and may also be any number. A grounding element mounting section 130 extends from the plug-in section 110 in a direction opposite to the plug-in direction, the grounding element mounting section 130 includes a side wall 131 and at least one opening 133 provided on the side wall 131, and the opening communicates the inner side and the outer side of the side wall 131. The number of the at least one opening 133 may also be determined according to actual needs. For example, the number of the openings 133 may be one, two, three, or even more, the opening 133 is used to provide communication between the interior and exterior of the side wall 131, thereby exposing elements within the side wall 131 to the exterior of the side wall 131. As shown in FIG. 1, the number of the opening 133 is actually two, and the other opening 133 is provided on the other surface of the insulator 11 in a manner of being symmetrical with respect to the opening 133 which can be seen in FIG. 1. The grounding element 15 is mounted in the grounding element mounting section 130.

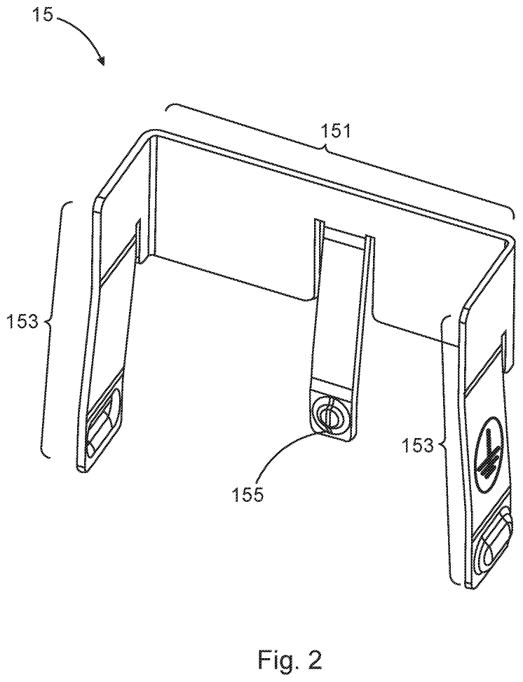

FIG. 2 is a schematic diagram of a grounding element according to embodiments of the present application. As shown in FIG. 2, the grounding element comprises a grounding element body 151 and a housing contact portion 153 provided at an end of the grounding element body 151; the grounding element body 151 is provided at the inner side of the side wall 131 of the grounding element mounting section 130, and the housing contact portion 153 is provided on the outer side of the side wall 131 through the opening 133. The grounding element 15 is made of a conductive material, so that the inner side and the outer side of the side wall 131 are electrically connected. Specifically, a ground wire can be provided at the inner side of the side wall 131, and is electrically connected to the housing contact portion 153 at the outer side of the side wall 131 through the grounding element body 151 of the grounding element 15, so as to conduct power leaked from an element contacting the housing contact portion 153 to the ground wire, thereby achieving grounding.

As shown in FIG. 1, the contact piece 17 comprises a contact piece mounting portion 171 and a contact 173 extending from the contact piece mounting portion 171 in the plug-in direction, the contact piece mounting portion 171 mounting the contact piece 17 to the insulator 11, and the contact 173 extending into the through hole 111.

The insulator 11 is generally used to hold the contact piece 17, and the contact 173 of the contact piece 17 actually provides the assembly of the plug-in connector component with an electrical connection to another assembly of a plug-in connector component.

In this way, a grounding element is provided in the assembly of the plug-in connector component, so as to provide grounding for the assembly of the plug-in connector component, thereby improving the safety of the assembly of the plug-in connector component; moreover, various components in the assembly of the plug-in connector component are easily mounted together without using a screw mounting manner, and the mounting is simple and convenient.

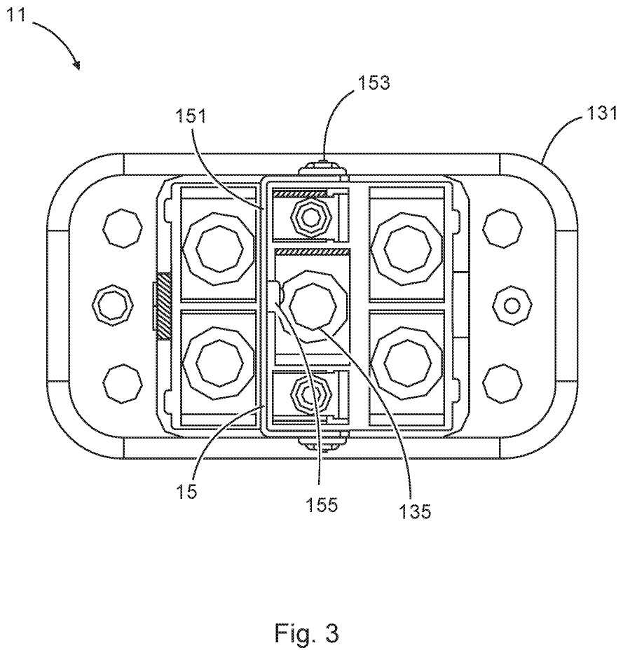

FIG. 3 is a cross-sectional view of an assembly of a plug-in connector component showing a grounding element according to embodiments of the present application. As shown in FIG. 3, according to exemplary embodiments of the present application, the insulator 11 further includes a ground wire fixing portion 135, the ground wire fixing portion 135 is provided in the center of the space surrounded by the side wall 131 of the grounding element mounting section 130, and is used for fixing a ground wire; and the grounding element body 151 includes a protective ground contact 155, the protective ground contact 155 being in contact with the ground wire.

In other words, according to the embodiments of the present application, the ground wire is accommodated inside the insulator of the assembly of the plug-in connector component; and by the grounding element, the ground wire can be connected to the outside of the insulator 11 of the assembly of the plug-in connector component. In this manner, a ground wire fixing manner is provided in the assembly of a connector component, such that the ground wire is provided in the center of the assembly of a connector component so as not to be exposed to the outside, the fixing of the ground wire is stable and safe, and the ground wire can be easily connected to the grounding element body 151 at the same time.

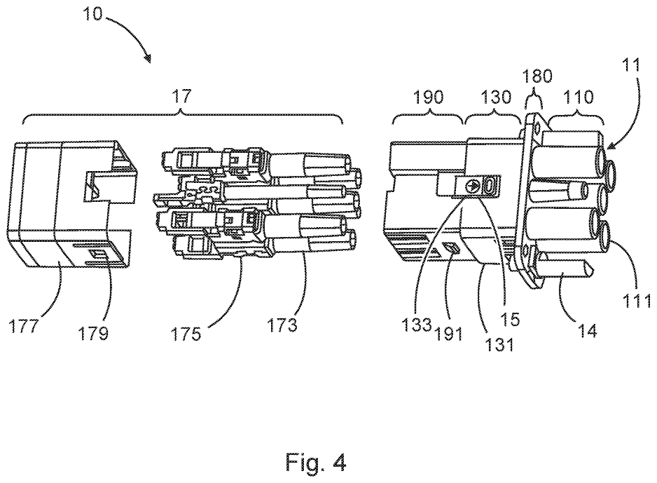

FIG. 4 is a schematic diagram of an assembly of a plug-in connector component according to another embodiment of the present application. In combination with FIGS. 1 and 4, according to exemplary embodiments of the present application, the insulator 11 further includes a contact piece mounting section 190 extending from the grounding element mounting section 130 in the direction opposite to the plug-in direction; and the contact piece mounting portion of the contact piece 17 includes a contact fixing portion 175 and a mounting plate 177 arranged on the periphery of the contact fixing portion 175, wherein the contact fixing portion 175 fixes the contact on the inner side of the mounting plate 177, and the mounting plate 177 mounts the contact piece mounting portion on the contact piece mounting section 190.

According to exemplary embodiments of the present application, the contact fixing portion 175 fixes the contact 173, and a suitable fitting piece may be provided on the contact fixing portion 175, for fitting onto the mounting plate 177, so that the mounting plate 177, the contact fixing portion 175 and the contact 173 form an integrated contact piece 17. In this manner, the contact piece is easily mounted in the assembly of the plug-in connector component, and at the same time, the grounding element is facilitated to be fixed in the assembly of the plug-in connector component, thereby realizing a simple mounting manner of the assembly of the plug-in connector component.

As shown in FIG. 4, according to exemplary embodiments of the present application, a first fixing structure 191 is arranged on the outer side of the contact piece mounting section 190, a second fixing structure 179 engaging with the first fixing structure 191 is arranged on the mounting plate 177, and the contact piece mounting portion 171 is mounted on the contact piece mounting section 190 by the engagement of the first fixing structure 191 with the second fixing structure 179.

According to exemplary embodiments of the present application, the first fixing structure 191 is a protrusion protruding outward from the side wall 131 of the insulator 11 and used as a fastener. The second fixing structure 179 is an opening formed on the mounting plate 177. When the contact piece 17 is assembled to the insulator 11, the mounting plate 177 is engaged with the insulator 11 by the protrusion and the opening. It should be understood that the first fixing structure 191 and the second fixing structure 179 are not limited thereto. The first fixing structure 191 may also comprise a guide member, such as an elongated protrusion, and the second fixing structure 179 comprises a sliding groove cooperating with the elongated protrusion. When the contact piece 17 is assembled on the insulator 11, the sliding groove of the contact piece 17 is aligned with the elongated protrusion, and the protrusion slides into the sliding groove, thereby facilitating alignment of the contact piece 17 and the insulator 11 during assembly. The structures of the first fixing structure 191 and the second fixing structure 179 may also be exchanged, as long as the first fixing structure 191 and the second fixing structure 179 can be clamped and fixed. In this way, the contact piece can be quickly mounted to the contact piece mounting section of the insulator without using tools such as screws for connection.

As shown in FIG. 4, according to exemplary embodiments of the present application, the assembly 10 of the plug-in connector component further comprises a coding element 14. The coding element 14 is arranged on one side of the plug-in section of the insulator and extends along the plug-in direction; and the assembly of the plug-in connector component can be plug-connected with the assembly of the mating plug-in connector component if the coding element 14 is matched with a mating coding element of the assembly of the mating plug-in connector component. As shown in FIG. 4, the coding element 14 is, for example, a pin which extends along the plug-in direction and has a semi-circular cross section in the plug-in direction. The coding element 14 may be rotated in the plug-in direction, such that the cross-sectional position of the semi-circle changes, and thus only when the cross-sectional position of a coding element of the assembly of the mating plug-in connector component matches said cross-sectional position, can said components be connected to each other. In this way, multiple coding forms are provided for the assembly of the plug-in connector component, thereby facilitating connection of the assembly of the plug-in connector component to an assembly of a correct mating plug-in connector component, and avoiding connection to wrong devices.

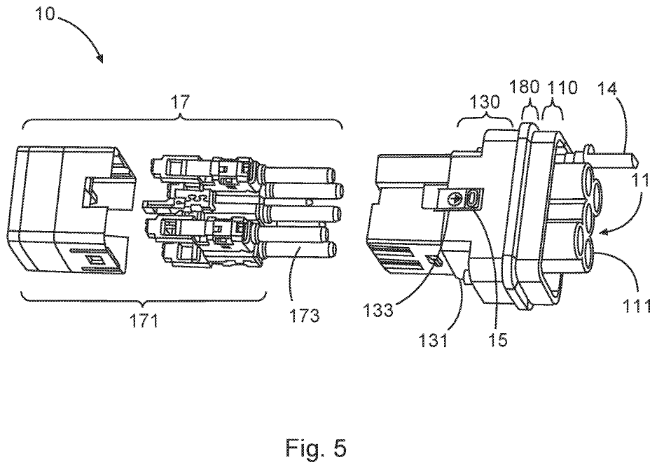

FIG. 5 is a schematic diagram of an assembly of a mating plug-in connector component according to embodiments of the present application. Specifically, a female connector of a plug-in connector is shown in FIGS. 1 and 4, and a male connector of a plug-in connector is shown in FIG. 5.

As shown in FIG. 5, according to exemplary embodiments of the present application, in the case of the assembly 10 of the plug-in connector component being plug-connected with the assembly of the mating plug-in connector component, the contact 173 of the contact piece 17 of the assembly of the plug-in connector component is electrically connected to a mating contact of a contact piece of the assembly of the mating plug-in connector component.

The structure of the assembly of the mating plug-in connector component according to the embodiments of the present application as shown in FIG. 5 actually corresponds to and matches the assembly of the plug-in connector component as shown in FIGS. 1 and 4. In other words, the contact of the assembly of the mating plug-in connector component which serves as a male connector as shown in FIG. 5 will be inserted into the contact of the assembly of the plug-in connector component which serves as a female connector as shown in FIGS. 1 and 4; and the plug-in section of the assembly of the mating plug-in connector component which serves as a male connector as shown in FIG. 5 will be inserted into the plug-in section of the assembly of the plug-in connector component which serves as a female connector as shown in FIGS. 1 and 4. In addition, the coding elements 14 of the two will match each other, and the semi-circular cross-section of one coding element will match with the semi-circular cross-section of the other coding element to form a complete circle.

In this manner, when the assembly of the plug-in connector component is plug-connected with the assembly of the mating plug-in connector component, a safe and stable electrical connection between devices is provided.

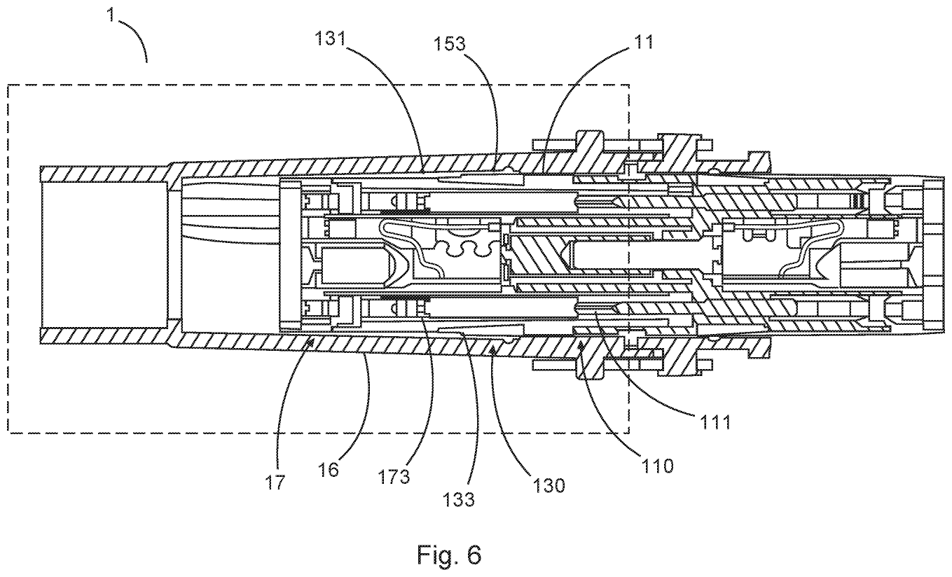

FIG. 6 is a schematic diagram of a plug-in connector component according to embodiments of the present application. According to another embodiment of the present application, a plug-in connector component 1 is further provided. The plug-in connector component 1 comprises: an assembly 10 of a plug-in connector component; and a housing 16.

As shown in FIG. 6, and in conjunction with FIGS. 1, 4, and 5, the assembly 10 of the plug-in connector component comprises an insulator 11, a grounding element 15, and a contact piece 17. The insulator 11 is made of an electrically insulating material, and the insulator 11 includes a plug-in section 110 and a grounding element mounting section 130. The plug-in section 110 can be plug-connected in a plug-in direction with a mating plug-in section of an insulator of an assembly of a mating plug-in connector component, and the plug-in section 110 is provided with a through hole 111 for accommodating a contact. The grounding element mounting section 130 extends from the plug-in section 110 in a direction opposite to the plug-in direction, the grounding element mounting section 130 includes a side wall 131 and at least one opening 133 provided on the side wall 131, and the opening 133 communicates the inner side and the outer side of the side wall 131. The grounding element 15 is mounted in the grounding element mounting section 130, and comprises a grounding element body 151 and a housing contact portion 153 provided at an end of the grounding element body 151; the grounding element body 151 is provided at the inner side of the side wall 131 of the grounding element mounting section 130, and the housing contact portion 153 is provided on the outer side of the side wall 131 through the opening 133. The contact piece 17 comprises a contact piece mounting portion 171 and a contact 173 extending from the contact piece mounting portion 171 in the plug-in direction, the contact piece mounting portion 171 mounting the contact piece 17 to the insulator 11, and the contact 173 extending into the through hole 111. A housing 16 includes an inner space for mounting the insulator 11, and the housing contact portion 153 of the grounding element 15 is in ground contact with the housing 16. The housing 16 may be a part handheld by a user, and the housing 16 is electrically connected to a ground wire through the grounding element 15 to be grounded, thereby protecting the safety of a user when electricity leakage occurs to the device, and preventing damage to the device due to a short circuit. In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, the insulator includes a housing mounting section between the plug-in section and the grounding element mounting section and protruding circumferentially, the housing mounting section mounting the insulator to the housing. For example, the housing mounting section may be provided with a first fastening structure, a second fastening structure is provided at a corresponding position of the housing, and the first fastening structure matches the second fastening structure, so that when the housing is assembled to the insulator, the two are clamped and fixed. A threaded opening may also be provided on the housing mounting section, so as to fix the housing to the housing mounting section by screws. In this way, a stable connection manner between the housing and the insulator is achieved.

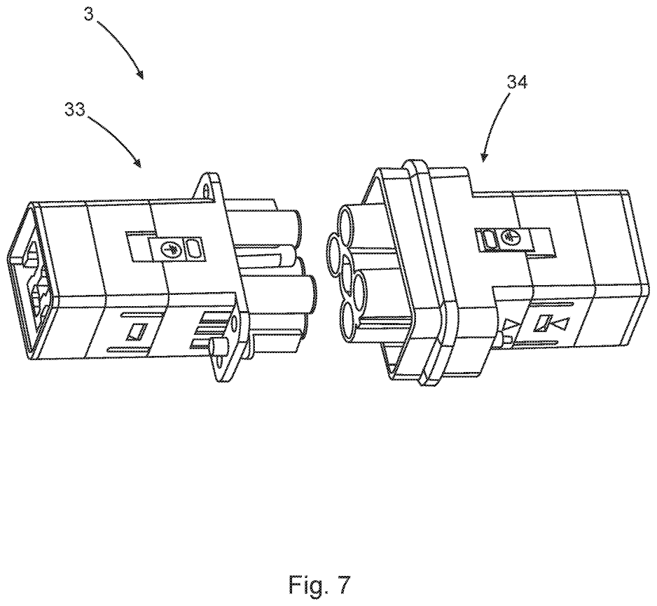

FIG. 7 is a schematic diagram of a plug-in connector system according to embodiments of the present application. As shown in FIG. 7, embodiments of the present application further provide a plug-in connector system 3. The plug-in connector system 3 comprises a first plug-in connector component 31 and a mating second plug-in connector component 33 in plug-in connection; for specific configurations of the first plug-in connector component 31 and the mating second plug-in connector component 33, refer to FIG. 1 to FIG. 6 and corresponding contents in the description. Specifically, as shown in FIG. 7, the first plug-in connector component 31 and the mating second plug-in connector component 33 are a male connector and a female connector respectively; and when the two are plug-connected, as for the cross-sections thereof, reference can be made to FIG. 6, which will not be repeated herein. In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

According to exemplary embodiments of the present application, in the case of the first plug-in connector component being plug-connected with the mating second plug-in connector component, the contact of the first plug-in connector component is electrically connected to a contact of the mating second plug-in connector component. In this manner, when the assembly of the plug-in connector component is plug-connected with the assembly of the mating plug-in connector component, a safe and stable electrical connection between devices is provided.

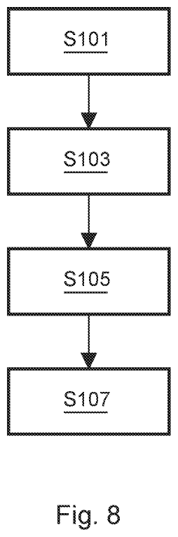

Embodiments of the present application further provide a method for mounting an assembly of a plug-in connector component. FIG. 8 is a flowchart of a method for mounting an assembly of a plug-in connector component according to embodiments of the present application. As shown in FIG. 8, in conjunction with FIGS. 1-7, the method for mounting an assembly of a plug-in connector component comprises: step S101, mounting a grounding element 15 in a grounding element mounting section 130 of an insulator 11 of the assembly, wherein a grounding element body 151 of the grounding element 15 is provided at the inner side of a side wall 131 of the grounding element mounting section 130, and a housing contact portion 153 of the grounding element 15 is provided on the outer side of the side wall 131 through an opening 133 provided on the side wall 131; specifically, the grounding element body 151 is in contact with a ground wire on the inner side of the side wall 131; step S103: fixing a contact 173 on the inner side of a mounting plate 177 through a contact fixing portion 175; and step S105, mounting a contact piece mounting portion 171 on a contact piece mounting section 190 through the mounting plate 177, so that the contact 173 extends into a through hole 111 of a plug-in section of the insulator 11. In this way, a grounding element is provided in the assembly of the plug-in connector component, so as to provide grounding for the housing of the assembly of the plug-in connector component, thereby improving the safety of the assembly of the plug-in connector component; moreover, various components in the assembly of the plug-in connector component are easily mounted together without using a screw mounting manner, and the mounting is simple and convenient.

As shown in FIG. 8, according to exemplary embodiments of the present application, the method for mounting an assembly of a plug-in connector component further comprises: step S107, mounting the insulator 11 to a housing 16 by a housing mounting section 180 of the insulator 11, and the housing contact portion 153 of the grounding element 15 being in ground contact with the housing 16.

Embodiments of the present application provide a technical solution of an assembly of a plug-in connector component, and a plug-in connector component and system, so as to at least solve the technical problem of inconvenience in an assembling manner of multiple components of a plug-in connector, and achieve the technical effects of easily and safely grounding the plug-in connector and easily assembling the plug-in connector.

In the described embodiments of the present application, the description of each embodiment has its own emphasis. For the part not detailed in a certain embodiment, please refer to the relevant description in other embodiments.

In the several embodiments provided in the present application, it should be understood that the disclosed technical content may be implemented in other manners. The apparatus embodiments described above are merely illustrative. For example, the division of a unit or a module is only a logical function division, and in actual implementation, there may be another division manner, for example, multiple units or modules or assemblies may be combined, or can be integrated into another system, or some features can be ignored or not executed. In addition, the coupling or direct coupling or communication connection shown or discussed may be an indirect coupling or communication connection through some interfaces, modules or units, and may be electrical or other forms.

The units or modules described as separate components may or may not be physically separated, and the components displayed as units or modules may or may not be physical units or modules, that is, may be located in one place, or may be distributed in a plurality of network units or modules. Some or all of the units or modules may be selected according to actual needs to achieve the purpose of the solutions of the embodiments.

The units or modules described as separate components may or may not be physically separated, and the components displayed as units or modules may or may not be physical units or modules, that is, may be located in one place, or may be distributed in a plurality of network units or modules. The described integrated unit or module can be embodied in the form of hardware or in the form of a software functional unit or module.

If the integrated unit is implemented in the form of a software functional unit and is sold or used as an independent product, the integrated unit can be stored in a computer-readable storage medium. On the basis of such understanding, the part of the technical solutions of the present application that contributes in essence or to the prior art or all or part of the technical solutions may be embodied in the form of a software product. The computer software product is stored in a storage medium and comprises several instructions to enable a computer device (which may be a personal computer, a server or a network device, etc.) to execute all or some of the steps of the method described in various embodiments of the present application. The foregoing storage medium comprises: media such as a USB flash disk, a Read-Only Memory (ROM), a Random Access Memory (RAM), a removable hard disk, a magnetic disk, or an optical disk, and the like which can store program codes.

The description above only relates to particularly advantageous embodiments of the present application. It should be noted that for a person of ordinary skill in the present technical field, several improvements and modifications can also be made, and these improvements and modifications shall also be considered as within the scope of protection of the present application. Additionally, aspects of the various embodiments described above can be combined to provide further embodiments

In general, in the following claims, the terms used should not be construed to limit the claims to the specific embodiments disclosed in the specification and the claims, but should be construed to include all possible embodiments along with the full scope of equivalents to which such claims are entitled.

1. An assembly of a plug-in connector component, comprising:
an insulator, the insulator being made of an electrically insulating material, the insulator comprising:
a plug-in section, the plug-in section being able to be plug-connected in a plug-in direction with a mating plug-in section of an insulator of an assembly of a mating plug-in connector component, the plug-in section being provided with a through hole for accommodating a contact; and
a grounding element mounting section, the grounding element mounting section extending from the plug-in section in a direction opposite to the plug-in direction, the grounding element mounting section including a side wall and at least one opening on the side wall, the opening communicating an inner side and an outer side of the side wall;
a grounding element, the grounding element being mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening: and
a contact piece, the contact piece comprising a contact piece mounting portion and a contact extending from the contact piece mounting portion in the plug-in direction, the contact piece mounting portion mounting the contact piece to the insulator, and the contact extending into the through hole of the plug-in section.

2. The assembly of the plug-in connector component according to claim 1, wherein:
the insulator further includes a ground wire fixing portion, the ground wire fixing portion is provided in the center of the space surrounded by the side wall of the grounding element mounting section, and is used for fixing a ground wire; and
the grounding element body includes a protective ground contact, the protective ground contact being in contact with the ground wire.

3. The assembly of the plug-in connector component according to claim 1, wherein:
the insulator further includes a contact piece mounting section extending from the grounding element mounting section in the direction opposite to the plug-in direction, and
the contact piece mounting portion of the contact piece includes a contact fixing portion and a mounting plate arranged on a periphery of the contact fixing portion, wherein the contact fixing portion fixes the contact on an inner side of the mounting plate, and the mounting plate mounts the contact piece mounting portion on the contact piece mounting section.

4. The assembly of the plug-in connector component according to claim 3, wherein:
a first fixing structure is arranged on an outer side of the contact piece mounting section, a second fixing structure engaging with the first fixing structure is arranged on the mounting plate, and the contact piece mounting portion is mounted on the contact piece mounting section by the engagement of the first fixing structure with the second fixing structure.

5. The assembly of the plug-in connector component according to claim 1, further comprising:
a coding element, the coding element being arranged on one side of the plug-in section of the insulator and extending along the plug-in direction; and
the assembly of the plug-in connector component can be plug-connected with the assembly of the mating plug-in connector component if the coding element is matched with a mating coding element of the assembly of the mating plug-in connector component.

6. The assembly of the plug-in connector component according to claim 1, wherein:
in the case of the assembly of the plug-in connector component being plug-connected with the assembly of the mating plug-in connector component, the contact of the contact piece of the assembly of the plug-in connector component is electrically connected to a mating contact of a contact piece of the assembly of the mating plug-in connector component.

7. A plug-in connector component, comprising:
an assembly of the plug-in connector component, the assembly comprising:
an insulator, the insulator being made of an electrically insulating material, the insulator comprising:
a plug-in section, the plug-in section being able to be plug-connected in a plug-in direction with a mating plug-in section of an insulator of an assembly of a mating plug-in connector component, the plug-in section being provided with a through hole for accommodating a contact; and
a grounding element mounting section, the grounding element mounting section extending from the plug-in section in a direction opposite to the plug-in direction, the grounding element mounting section including a side wall and at least one opening on the side wall, the opening communicating an inner side and an outer side of the side wall;
a grounding element, the grounding element being mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening; and
a contact piece, the contact piece comprising a contact piece mounting portion and a contact extending from the contact piece mounting portion in the plug-in direction, the contact piece mounting portion mounting the contact piece to the insulator, and the contact extending into the through hole of the plug-in section; and
a housing, the housing including an inner space for mounting the insulator, and the housing contact portion of the grounding element being in ground contact with the housing.

8. The plug-in connector component according to claim 7, wherein:
the insulator includes a housing mounting section between the plug-in section and the grounding element mounting section and protruding circumferentially, the housing mounting section mounting the insulator to the housing.

9. A plug-in connector system, comprising a first plug-in connector component and a mating second plug-in connector component in plug-in connection, wherein the first plug-in connector component and the mating second plug-in connector component respectively include:
an assembly of the plug-in connector component, the assembly comprising:
an insulator, the insulator being made of an electrically insulating material, the insulator comprising:
a plug-in section, which can be plug-connected in a plug-in direction with a mating plug-in section of an insulator of an assembly of another mating plug-in connector component, the plug-in section being provided with a through hole for accommodating a contact; and
a grounding element mounting section, the grounding element mounting section extending from the plug-in section in a direction opposite to the plug-in direction, the grounding element mounting section including a side wall and at least one opening on the side wall, the opening communicating an inner side and an outer side of the side wall;
a grounding element, mounted in the grounding element mounting section and comprising a grounding element body and a housing contact portion provided at an end of the grounding element body, the grounding element body being provided at the inner side of the side wall of the grounding element mounting section, and the housing contact portion is provided on the outer side of the side wall through the opening;
a contact piece, comprising a contact piece mounting portion and a contact extending from the contact piece mounting portion in the plug-in direction, the contact piece mounting portion mounting the contact piece to the insulator, and the contact extending into the through hole of the plug-in section; and
a housing, including an inner space for mounting the insulator, and the housing contact portion of the grounding element being in ground contact with the housing.

10. The plug-in connector system according to claim 9, wherein:
in the case of the first plug-in connector component being plug-connected with the mating second plug-in connector component, the contact of the first plug-in connector component is electrically connected to a contact of the mating second plug-in connector component.

11. A method for mounting an assembly of a plug-in connector component, the assembly of a plug-in connector component including:
an insulator, the insulator being made of an electrically insulating material, the insulator comprising:
a plug-in section, the plug-in section being able to be plug-connected in a plug-in direction with a mating plug-in section of an insulator of an assembly of a mating plug-in connector component, the plug-in section being provided with a through hole for accommodating a contact; and
a grounding element mounting section, the grounding element mounting section extending from the plug-in section in a direction opposite to the plug-in direction, the grounding element mounting section including a side wall and at least one opening on the side wall, the opening communicating an inner side and an outer side of the side wall;
a grounding element, the grounding element being mounted in the grounding element mounting section and comprising a grounding element body and a housing contact portion provided at an end of the grounding element body, the grounding element body being provided at the inner side of the side wall of the grounding element mounting section, and the housing contact portion being provided on the outer side of the side wall through the opening; and
a contact piece, the contact piece comprising a contact piece mounting portion and a contact extending from the contact piece mounting portion in the plug-in direction, the contact piece mounting portion mounting the contact piece to the insulator, and the contact extending into the through hole of the plug-in section, the method comprising:
mounting the grounding element in the grounding element mounting section of the insulator of the assembly, wherein the grounding element body of the grounding element is provided at the inner side of the side wall of the grounding element mounting section, and a-the housing contact portion of the grounding element is provided on the outer side of the side wall through the opening provided on the side wall;
fixing a contact on an inner side of a mounting plate through a contact fixing portion; and
mounting the contact piece mounting portion on the contact piece mounting section through the mounting plate so that the contact extends into the through hole the plug-in section of the insulator.

12. The method according to claim 11, further comprising:
mounting the insulator to a housing by a housing mounting section of the insulator, and the housing contact portion of the grounding element being in ground contact with the housing.
